(19) United States
(12) Patent Application Publication
(10) Pub. No.: US 2026/0233803 A1
(43) Pub. Date: Aug. 13, 2026

(54) Device and Method for Actuating a Motor of an Electric Bicycle

(71) Applicant: Robert Bosch GmbH, Stuttgart (DE)

(72) Inventors: Merlin Martin Manewald, Reutlingen (DE); Franz Hofmann, Besigheim (DE); Julian Hau, Reutingen (DE); Gregor Goebel, Moessingen (DE); Matthias Weinmann, Balingen (DE); Joseph Reck, Weil Im Schoenbuch (DE)

(21) Appl. No.: 19/471,521

(22) PCT Filed: Mar. 28, 2024
(86) PCT No.: PCT/EP2024/058655

§ 371 Date: Oct. 1, 2025

(30) Foreign Application Priority Data
Apr. 3, 2023 (DE) 10 2023 203 075.6

(51) Int. Cl. B62M 6/45; B62M 6/55

(52) U.S. Cl. CPC B62M 6/45; B62M 6/55

(57) ABSTRACT

A device for controlling a motor of an electric bicycle includes a control unit which is configured to control the motor of the electric bicycle in a first operating mode and a second operating mode. In the first operating mode, the motor is controlled such that the motor does not provide a motor torque. In the second operating mode, the motor is controlled such that the motor provides a motor torque at least for a short time. The control unit is further configured to switch from the first operating mode to the second operating mode when a first condition and a second condition are met. The first condition is met when a rider torque exerted by a rider of the bicycle on the pedals of the bicycle is detected, said torque being above a predefined first threshold value. The second condition is dependent on a progression over time of the rider torque, a motor rotational speed of the motor and/or a user input.

### PRIOR ART

The present invention relates to a method and a device for controlling a motor of an electric bicycle.

Electric bicycles, in particular pedelecs, provide motor assistance as a function of a rider torque exerted by a rider. This is detected by a torque sensor. To ensure safe operation, motor assistance is only released when certain conditions are met. This is necessary to avoid rotating the motor without a rider request due to disrupted or erroneous sensor signals. The start-up operation is of particular importance here. This must be reliably detected based on various sensor signals in order for the full motor assistance to be released.

For current pedelecs, a rider torque is usually detected via a torque sensor. Only when a rider torque is present over a threshold and a further signal that implies a start-up request is detected is the motor assistance also released. This plausibility check with, for example, a second sensor is required so that the start-up request is safely and reliably detected.

This further signal may be the rider cadence detected via a cadence sensor. However, this has the drawback that often large free travel occurs in a pedaling operation of the rider before the motor assistance is used. For example, a cadence sensor operates with 36 teeth, allowing free travel of up to 10° before a cadence is detected and motor assistance can be provided.

Alternatively, the second signal is often used to check whether there is an acceleration in the direction of travel, which is determined, for example, by means of an accelerometer. Forward acceleration must be detected before motor assistance is released. However, this may also be present when the bicycle is traveling downhill, which means that threshold values for detecting acceleration are often set high so that acceleration can be reliably associated with a start-up operation. However, such acceleration values are often not achieved with starting slowly or starting on a hill.

Also, movements of magnets, i.e. magnets which are arranged for example on a spoke of the cycle, are often detected by means of reed contacts arranged on a frame of the electric bicycle. If such a magnet passes the reed contact, a speed pulse is generated. For example, the motor assistance is not released until such a speed pulse is detected. However, this can only occur after a full wheel revolution in the worst case scenario, which leads to a delay in the motor assistance. It is also not apparent to the rider when the assistance is provided, as the position of the magnet is unknown at the time of the start-up request, and thus the angle to be traveled until the reed contact is passed is random.

Regardless of the conditions mentioned above, however, it is always necessary for the driver torque to exceed a threshold so that conditions for motor torque release may be met. The necessary second condition means that cases where, for example, a rider does not have the necessary strength to move the pedelec on a slope cannot be covered. In such a case, neither a positive rider's cadence, forward acceleration, or speed pulse occurs.

### DISCLOSURE OF THE INVENTION

The device according to the invention for controlling a motor of an electric bicycle comprises a control unit, which is configured to control the motor of the electric bicycle in a first operating mode, wherein, in the first operating mode, the motor is controlled such that the motor does not provided a motor torque, and to control the motor of the electric bicycle in a second operating mode, wherein, in the second operating mode, the motor is controlled such that the motor provides a motor torque at least for a short time. The control unit is configured to switch from the first operating mode to the second operating mode when a first condition and a second condition are met. The first condition is met when a rider torque exerted by a rider of the cycle on the pedals of the cycle is detected, said torque being above a predefined first threshold value. The second condition is dependent on a progression over time of the rider torque, a motor rotational speed of the motor, and/or a user input.

The method according to the present invention for controlling an motor of an electric bicycle comprises controlling the motor of the electric bicycle in a first operating mode, wherein, in the first operating mode, the motor is driven such that the motor does not provide a motor torque, controlling the motor of the electric bicycle in a second operating mode, wherein, in the second operating mode, the motor is controlled such that the motor provides motor torque at least for a short time, and switching from the first operating mode to the second operating mode when a first condition and a second condition are met. In so doing, the first condition is met when a rider torque exerted by the rider of the bicycle on the pedals of the cycle is detected, said torque being above a predefined first threshold value. The second condition is dependent on a progression over time of the rider torque, a motor rotational speed of the motor, and/or a user input.

The control unit is, for example, a digital computing unit, which provides the information detected by sensors of the electric bicycle. For example, the control unit is connected to a torque sensor via which the rider torque exerted by the rider of the cycle on the pedals of the cycle is detected. Further preferably, the control unit is connected to a speed sensor via which the motor rotational speed of the motor is detected. Further preferably, the control unit is associated with an input unit via which a user input may be detected.

The motor of the electric bicycle is configured to assist a motor of the electric bicycle, i.e. provide motor assistance. In the first operating mode, the motor is controlled such that no support for propelling the electric bicycle is provided by the motor. For example, no supply voltage is provided to the motor.

In the second operating mode, the motor is controlled such that the motor provides motor torque at least for a short time. This is therefore advantageous because, in the second operating mode, it is already known that motor assistance is desired by a rider of the bicycle. Thus, the motor assistance may either already be provided based on an torque exerted by the rider or it may be checked whether further conditions have been met before longer-term motor assistance is provided. For example, in the second operating mode, the motor torque is provided only for a short time to check whether the motor is blocked or capable of rotating. If the motor is blocked, i.e. the motor cannot rotate, the control unit preferably switches back to the first operating mode.

The first condition is met when a rider torque exerted by the rider of the bicycle is detected, which is above a predefined first threshold value. This means that the torque sensor detects a sufficient rider torque, which indicates an intended pedaling operation of the rider of the bicycle. Among other things, the first condition ensures that unintended low loads on a pedal of the cycle or an unwanted deviation of an output signal of the torque sensor from a zero value are not interpreted as a start-up request. In addition, smaller errors or inaccuracies in the measurement signal of the torque sensor do not result in an unwanted start-up.

The second condition is dependent on a progression over time of the rider torque, a motor rotational speed of the motor, and/or a user input. This means that the progression over time of the rider torque, the motor rotational speed of the motor, and/or the user input are evaluated and the second condition is then met when the progression over time of the rider torque, the motor rotational speed, and/or the user input have a particular characteristic. These parameters, on which the second condition is dependent, have in common that they indicate a desire on the part of the rider of the electric bicycle for motor assistance, even if the rider is not able to move the pedals of the bicycle, for example because their strength is not sufficient on a slope. It is noted that the motor rotational speed of the motor is detected as part of testing the second condition, but rotation of the motor is not caused by the motor itself as it does not provide motor torque in the first operating mode. This means that the rotation of the motor leading to the motor rotational speed is caused by a movement of the electric bicycle, for example by reverse rolling on a slope.

The second condition may be formulated to be dependent on a combination of said parameters, in particular dependent on the progression over time of the rider torque and the motor rotational speed, the progression over time of the rider torque and the motor rotational speed, the progression over time of the rider torque and the user input, or dependent on the motor rotational speed and the user input.

The dependent claims show preferred further modifications of the invention.

Preferably, the second condition is dependent on the progression over time of the rider torque and is then met if the progression over time of the rider torque has a predefined characteristic. Thus, with the progression over time of the rider torque, not only a torque value of the rider torque is considered, as is possible, for example in the context of the first condition, but rather the rider torque is considered over time. This results in additional information. For example, it is also possible to detect whether the rider of the electric bicycle is performing a sustained action that indicates a desire for assistance from the motor.

Preferably, the progression over time of the rider torque has the predefined characteristic if the detected rider torque is greater than a second threshold value over a predefined time period, a gradient of the detected rider torque is greater than a third threshold value, and/or an integral is greater than a fourth threshold value over the progression over time of the detected rider torque over a predefined time interval. By means of the second threshold value, it can thus be defined how long the rider must maintain a rider torque in order to conclude that they wish to receive motor assistance. The second threshold value is preferably greater than or equal to the first threshold value. The third threshold value is in this case preferably the same as or similar to the first threshold value. Based on the third threshold value, in particular, it can be defined how dynamically the rider must act on the pedal of the cycle in order to be able to conclude a rider's request for motor assistance. By using the integral and the fourth threshold value, a system is created in which both a comparatively short application of a high rider torque or a comparatively long application of a rather low rider torque results in the second condition being met and thus motor assistance. The mentioned predefined properties are combinable with one another. Thus, optionally, either two or all of said predefined properties must be present for the second condition to be met.

Preferably, the second condition is dependent on the motor rotational speed of the motor and is then met when the motor rotational speed is below a predefined fifth (negative) threshold value, wherein the motor rotational speed of the motor is caused by reverse rolling of the bicycle and thus is negative. The motor rotational speed is positive when the motor is rotated in a direction used to propel the bicycle. The motor rotational speed is thereby negative if the motor is rotated in a direction caused by reverse rolling of the bicycle.

By checking whether the motor rotational speed of the motor is above a predefined fifth threshold value, it is detected that the electric bicycle is rolling backwards when motor assistance is requested. This typically occurs when a rider of the bicycle does not apply enough force to accelerate the cycle uphill.

Further preferably, the second condition is dependent on the user input and is then met when a predefined input is made by a user via an input unit. Thus, it is advantageous if a user can perform any predefined action to consciously indicate that motor assistance is desired.

The input unit is preferably a button and the user input is an actuation of the button over a predefined time. Preferably, such a button is arranged on a handlebar of the electric bicycle. The button can also be implemented digitally, for example on a touch screen.

Further preferably, the second condition to be met or a combination of second conditions to be met is selected depending on a current driving situation determined based on detected sensor data. For example, sensors of the electric bicycle determine whether the electric bicycle is on a slope. If so, the second condition may be optimized for this situation. For example, the second condition is selected such that it depends on the gradient of the detected rider torque and the duration for which the detected rider torque exceeds the first threshold value. This means that a second condition for the situation can be selected, which increases the driving comfort depending on the current driving situation.

Preferably, the control unit is configured to determine, in the second operating mode, whether the motor torque provided by the motor results in movement of the motor and to switch to the first operating mode when the motor torque provided by the motor does not result in movement of the motor, and to switch to a third operating mode if the motor torque provided by the motor results in movement of the motor. This prevents the motor from providing continuous assistance that does not result in movement of the electric bicycle, but could result in overheating of the motor.

It is also advantageous if the control unit is configured to control the motor of the electric bicycle in the third operating mode, such that the motor torque is provided dependent on the rider torque. Thus, it is advantageous to provide a regular driving mode after a test of whether the motor is blocked.

### BRIEF DESCRIPTION OF THE DRAWINGS

Exemplary embodiments of the invention are explained in detail below with reference to the accompanying drawing. The drawing shows:

FIG. 1 an illustration of an electric bicycle with a device according to the invention,

FIG. 2 a flow diagram of a method according to the invention for controlling a motor of an electric bicycle,

### EMBODIMENTS OF THE INVENTION

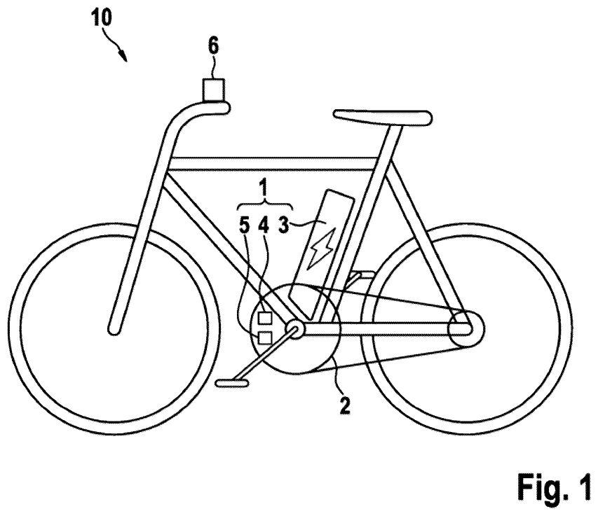

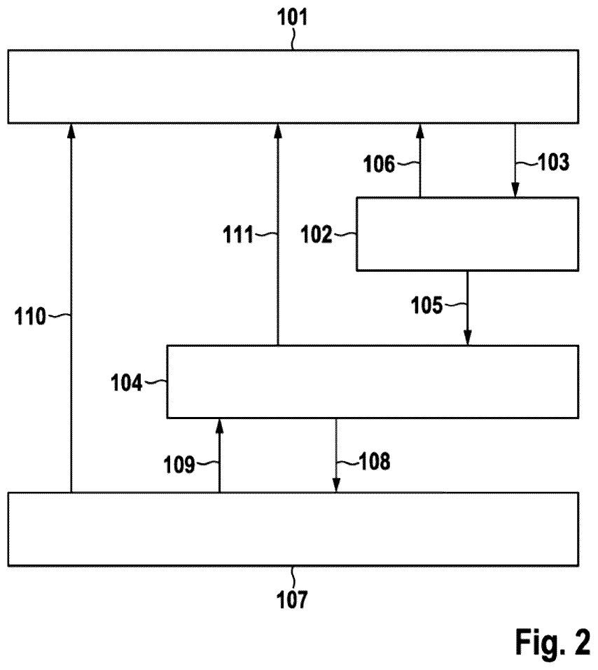

FIG. 1 is a schematic illustration of an electric bicycle 10, for example a pedelec, which comprises a device 1 according to the invention for controlling a motor 2 of the electric bicycle 10. The device 1 performs the method 100 according to the invention for controlling the motor 2 of the electric bicycle 10, wherein an example flow diagram of the method 100 is shown in FIG. 2.

The device 1 comprises at least one control unit 3 configured to carry out the method 100 according to the invention. A motor rotational speed sensor 4 is arranged on the motor 2 of the electric bicycle 10, which is a component of the device 1 or provides this information. A rider torque sensor 5, which is a component of the device 1 or provides this information, is further arranged on the electric bicycle 10.

The control unit 3 is configured to control the motor 2 of the electric bicycle. The control unit 3 is configured to control the motor 2 at least in a first operating mode 101 and a second operating mode 102. In the embodiment described herein, the control unit 3 is further configured to control the motor 2 of the electric bicycle 10 also in a third operating mode 104 and in a fourth operating mode 107. Depending on the present operating mode, the motor 2 of the electric bicycle 10 is controlled in different ways.

Referring to FIG. 2, controlling the motor 2 initially occurs in the first operating mode 101. In the first operating mode 101, the motor 2 is controlled such that no assistance for propelling the electric bicycle 10 is provided by the motor 2. Thereby, no motor torque is provided by the motor 2. The first operating mode 101 is thus a mode, typically present when the electric bicycle 10 is stationary and no motor assistance is desired by the user.

In the second operating mode 102, the motor 2 is controlled by the control unit 3 such that the motor 2 provides motor torque at least for a short time.

A decision is to be made by the control unit 3 when a change 103 from the first operation mode 101 to the second operation mode 102 is to occur. This change is to be made when it is determined that motor assistance by the motor 2 is desired by a rider of the electric bicycle 10. It is a challenge here that no unwanted movements of the pedals result in already providing motor assistance, as this would result in unwanted movement of the electric bicycle 10. At the same time, it is strived to detect the desire for assistance by the motor 2 as quickly as possible, but also reliably, so that the electric bicycle 10 has a dynamic driving behavior. This is achieved by the device 1 by switching from the first operation mode 101 to the second operation mode 102 when two conditions are met. Thus, the control unit 3 checks whether the parameters defined with a first condition and the parameters defined with a second condition are given, and in response to the existence of these parameters defined by the conditions, a change 103 from the first operating mode 101 to the second operating mode 102 occurs.

The first condition is met when a rider torque exerted by the rider of the bicycle 10 on the pedals of the bicycle 10 is detected, said torque being above a predefined first threshold value. For example, an output signal from the rider torque sensor 5 is compared to a comparison value predefined by the first threshold value, and if the measured rider torque exceeds the first threshold value, the first condition is met. For example, the first threshold value could be selected at 12.5 Nm and the first condition is met when the rider of the electric bicycle 10 exerts a rider torque that exceeds 12.5 Nm.

Among other things, the second condition ensures that the motor torque is not yet provided by the motor 2 if a comparatively high rider torque is exerted undesirably. This may be the case, for example, if a start-up operation fails, for example, because the operator slips off the pedal, or if the operator only rests his leg on the pedal. In addition, it is ensured that smaller errors and inaccuracies in the sensor signal are not incorrectly recognized as the rider's start-up request. The detection of a request for motor assistance is to be reliable by means of the second condition independent of a present driving situation or terrain situation. Here, it is desirable to detect the second condition in a responsive manner so that the motor assistance is quickly provided when the rider requests it. This is important, for example, when starting up on a hill, because lack of motor assistance could lead to the reverse rolling of the cycle.

Various options for designing the second condition are listed below. These are combinable with each other and each of these exemplary second conditions is dependent on a progression over time of the rider torque, an motor rotational speed of the motor 2, or a user input.

For example, the second condition is designed to depend on the rider torque progression over time and then be met when the rider torque progression over time has a predefined characteristic.

For example, the predefined characteristic is that the detected rider torque is greater than a second threshold value over a predefined period of time. The second threshold value is greater than the first threshold value of the first condition. Thus, preferably, the second threshold value is selected in a range between 50 Nm to 100 Nm, for example, to 80 Nm. Thus, for the second condition to be met, the rider torque detected by the rider torque sensor 5 must be above the second threshold value for an applicable time. The applicable time is preferably selected in a range between 30 ms and 400 ms, for example at 200 ms.

For example, the predefined characteristic is that a gradient of the detected rider torque is greater than a third threshold value. Thus, a gradient of a torque signal of the rider torque sensor 5 over an applicable time must be above the third threshold value. The applicable time is preferably selected in a range between 30 ms and 400 ms, for example at 200 ms. The third threshold value is preferably selected in a range between 50 Nm/s to 500 Nm/s, for example to 200 Nm/s. In this way, for example, it is prevented that a slow increase in the rider torque results in a fulfillment of the second condition and motor assistance by the motor 2. This covers, for example, situations in which the rider is allowed to rest on the pedal without starting up or keeping a cycle in position on a slope by a rider torque. In addition, the error case of a slow drift would be intercepted in the sensor signal.

The predefined characteristic is, for example, that an integral over the progression over time of the detected rider torque over a predefined time interval is greater than a fourth threshold value. This means that the integrated rider torque signal detected by the rider torque sensor 5 and integrated over an applicable time must be above the fourth threshold value. Mathematically, this means that the result of the following term is compared to the fourth threshold value:

$${\int }_{t - {t}_{1}}^{t} \qquad {M}_{rider} \qquad ( t ) dt$$

Here, t₁ is the applicable time and M_{rider}(t) is the rider torque over time.

The second condition, as well as the first condition, may thus be derived from the measured rider torque provided by the rider torque sensor 5. However, this means that the second condition must meet harder criteria than the first condition.

Depending on possibly occurring error patterns of the rider torque sensor 5, which could lead to, for example, a triggering of the first condition, the aforementioned options for the second condition may also be combined with one another to prevent an unwanted change to the second operating mode. In one example implementation, the rider torque must be above 12.5 Nm to satisfy the first condition and the torque gradient must be above the third threshold value of 200 Nm/s for a period of 200 ms. In this combination in particular, the case of an impulsive dynamic start-up on slopes is covered. Thus, according to this example, it is also advantageous if the second condition is not met until the gradient of the detected rider torque is above the third threshold value for a predefined time. The high threshold value and the specific signal path (heavily increasing torque) reduces the risk of incorrect triggering of the motor assistance.

Alternatively or additionally, the second condition is dependent on the motor rotational speed of motor 2 detected by the speed sensor 4. The second condition is preferably met when the motor rotational speed of motor 2 is below a predefined fifth negative threshold. When the electric bicycle 10 is moved backward, the entire drive train also rotates backward. The drive train comprises the rear wheel, the pinion packet, the chain, the chainring, the pedals (only in systems without rider freewheel) and the motor 2 of the electric bicycle. This movement can be detected by a rotor position sensory system of the motor, which is used as a speed sensor 4, for example. This case occurs, for example, when the driver of the electric bicycle 10 tries to start on a hill does not generate enough rider torque to propel the electric bicycle 10 forward. Instead, the electric bicycle 10 rolls backward and the motor 2 also rotates backward. If the motor rotational speed of motor 2 is below an applicable negative threshold value, here the fifth threshold value, then the second condition is met. The motor rotational speed of motor 2 considered with the second condition is thereby caused by reverse rolling of the bicycle 10.

Alternatively or additionally, the second condition is dependent on the user input. The second condition is met, for example, when a predefined input is made by a user via an input unit. The predefined input is, for example, an actuation of a button over a predefined time. Thus, the second condition may be a triggering of a button 6 (dedicated thereto), i.e. a knob, on an operation element of the electric bicycle 10. This may be a singular event. This means that button 6 is pressed once, or the button must be pressed for an applicable time in order for the second condition to be met. In the second case, button 6 can be assigned several functions, wherein, for example, the button for switching to an assistance mode can also be used as an input unit for the method according to the invention. Advantageously, direct assistance by the electric motor 2, which is triggered by actuating the button 6, is also here.

As has already been discussed, the second conditions set forth herein are mutually combinable. A second condition can thus consist of a plurality of sub-conditions.

Preferably, the second condition to be met or the combination of second conditions to be met is selected depending on a current driving situation determined based on detected sensor data. For example, the aforementioned triggering of the motor assistance in system may be triggered by a specific combination of second conditions and this is done only when a slope of the electric bicycle 10 is detected by a position sensor.

If the second condition is met, the control unit switches to the second operation mode 102. In the second operating mode 102, in the embodiment described herein, individual torque pulses are provided by the motor 2, detecting whether the motor 2 is rotating or not during the supply of the torque pulses. This is determined by the motor rotational speed sensor 4, by which the motor rotational speed of the motor 2 is detected. If, in the second operating mode 102, the intermittent provision of the motor torque does not result in rotation of the motor 2, the control unit switches back to the first operating mode 101, as blocking of the motor 2 is to be assumed. This switching back is carried out according to FIG. 2 in an alternating step 106.

If, on the other hand, the motor torque provided over a short time is determined to result in movement of the motor 2, then in an alternating step 105, the switch is made from the second operation mode 102 to a third operation mode 104. In the third operating mode 104, the motor 2 is controlled by the control unit 3 such that the motor torque is provided dependent on a rider torque. The rider torque is thereby detected by the rider torque sensor 5 and is converted to a requested motor torque by an associated algorithm, which is then provided by the motor 2. Thus, in the third operating mode 104, there is a typical regular driving operation of the electric bicycle 10.

The method shown in FIG. 2 further preferably includes motor blocking protection to protect the motor 2 upon a blockage following release of the motor assistance and operation of the control unit 3 in the third operating mode 104. For example, the control unit 3 switches to a fourth operating mode 107 when motor 2 is blocked in the third operating mode 104. In the fourth operating mode 107, in this case, the motor torque of the motor 2 is continuously decreased until the jam is unblocked. This prevents overheating of the motor 2. If the blocking is unblocked, the control unit 3 switches back to the third operating mode 104 in a switching step 109.

If there is no requirement for motor assistance, regardless of whether the control unit 3 is in the third operating mode 104 or the fourth operating mode 107, the control unit 3 returns to the first operating mode 101 in a respective associated switching step 110, 111.

In addition to the above description, reference is explicitly made to the disclosure of FIGS. 1 to 2.

1. A device for controlling a motor drive of an electric bicycle, comprising a control unit which is configured to:
control the motor of the electric bicycle in a first operating mode, wherein, in the first operating mode, the motor is controlled such that the motor does not provide a motor torque, and
control the motor of the electric bicycle in a second operating mode, wherein, in the second operating mode, the motor is controlled such that the motor provides a motor torque at least for a short time,
wherein the control unit is further configured to switch from the first operating mode to the second operating mode when a first condition and a second condition are met,
wherein the first condition is met when a rider torque exerted by a rider of the bicycle on pedals of the bicycle is detected, said torque being above a predefined first threshold value, and
wherein the second condition is dependent on a progression over time of the rider torque, a motor rotational speed of the motor, and/or a user input.

2. The device according to claim 1, wherein the second condition is dependent on the progression over time of the rider torque and is then met if the progression over time of the rider torque has a predefined characteristic.

3. The device according to claim 2, wherein the progression over time of the rider torque has the predefined characteristic if:
the detected rider torque is greater than a second threshold value over a predefined period of time,
a gradient of the detected rider torque is greater than a third threshold value, and/or
an integral over the progression over time of the detected rider torque over a predefined time interval is greater than a fourth threshold value.

4. The device according to claim 1, wherein the second condition is dependent on the motor rotational speed of the motor and is then met when the motor rotational speed of the motor is below a predefined fifth negative threshold value, and wherein the motor rotational speed of the motor is caused by reverse rolling of the wheel.

5. The device according to claim 1, wherein the second condition is dependent on the user input and is then met when a predefined input is made via an input unit by a user.

6. The device according to claim 5, wherein the input unit is a button, and the user input is an actuation of the button over a predefined time.

7. The device according to claim 1, wherein the second condition to be met or a combination of second conditions to be met is selected depending on a current driving situation determined based on detected sensor data.

8. The device according to claim 1, wherein the control unit is further configured to:
in the second operating mode, determine whether the motor torque provided by the motor results in movement of the motor,
switch to the first operating mode when the motor torque provided by the motor does not result in movement of the motor, and
switch to a third operating mode when the motor torque provided by the motor results in movement of the motor.

9. The device according to claim 8, wherein the control unit is further configured to control the motor of the electric bicycle in the third operating mode, such that the motor torque is provided dependent on the rider torque.

10. A method for controlling a motor of an electric bicycle, comprising:
controlling the motor of the electric bicycle in a first operating mode, wherein, in the first operating mode, the motor is controlled such that the motor does not provide a motor torque,
controlling the motor of the electric bicycle in a second operating mode, wherein, in the second operating mode, the motor is controlled such that the motor provides a motor torque for at least a short time, and
switching from the first operating mode to the second operating mode when a first condition and a second condition are met,
wherein the first condition is met when a rider torque exerted by a rider of the bicycle on pedals of the bicycle is detected, said torque being above a predefined first threshold value, and
wherein the second condition is dependent on a progression over time of the rider torque, a motor rotational speed of the motor, and/or a user input.
